(19) United States
(12) Patent Application Publication
(10) Pub. No.: US 2006/0072307 A1
(43) Pub. Date: Apr. 6, 2006

(54) Lantern

(76) Inventor: Jim Jozefowicz, Oakland Park, FL (US)

Correspondence Address: Mark D. Bowen;Stearns Weaver Miller, et al., Suite 1900, 200 East Broward Boulevard, Fort Lauderdale, FL, 33301, US

(21) Appl. No.: 10/959,521

(22) Filed: Oct. 6, 2004

(51) Int. Cl. F21V 35/00

(52) U.S. Cl. 362/161

(57) ABSTRACT

An oversized lantern capable of generating substantial amounts of light and heat, while providing the appeal of an open fire, is disclosed. The lantern includes a base having a reservoir for containing liquid fuel such as oil, a glass enclosure attached to the base for functioning as a wind shield, a plate that floats on top of the liquid fuel, and a plurality of wicks inserted in the plate. Ceramic simulated logs are disposed on the plate to simulate a campfire effect. The wicks can be manually adjusted to increase or decrease the size of the simulated fire. The base preferably includes a plurality of peripheral feet to elevate the base above the supporting surface to prevent corrosion.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to candle-type illumination devices, and more particularly to lantern-type devices.

2. Description of the Background Art

Typical portable candle lanterns use one candle housed inside a relatively small, candle holder assembly enclosed by a wind shield. Different types of wind lanterns are well known. These wind lanterns generally consist of a base that typically functions as a fuel reservoir, a glass enclosure attached to the base, and a wick inserted in the base. Such prior art wind lanterns are generally provided with ornamental design features and may be used in the home or outdoors, for example on porches or in the garden or the like.

One disadvantage present with typical portable candle lanterns is that they produce relatively small amounts of illumination and heat. Methods used to increase illumination and heat production include increasing the size and/or number of candles housed within the candle lantern. Simply increasing the number of candles, however, simply allows a substantial amount of heat to escape with the combustion gas and fails to maximize heat radiated to the surrounding area.

Accordingly, there exists a need for an improved lantern capable of generating substantial amounts of light and heat, while providing the appeal of an open fire.

### SUMMARY OF THE INVENTION

The present invention provides an improved, oversized wind lantern capable of generating substantial amounts of light and heat, while providing the appeal of an open fire. A lantern according to the present invention includes a base including a reservoir for liquid fuel such as oil, a glass enclosure attached to the base for functioning as a wind shield, a plate that floats on top of the liquid fuel, and a plurality of wicks inserted in the plate. In addition a number of ceramic simulated logs are disposed on the plate to simulate a campfire effect. The wicks can be manually adjusted to increase or decrease the size of the simulated fire. The base preferably includes a plurality of peripheral feet to elevate the base above the supporting surface to prevent corrosion.

Accordingly, it is an object of the present invention to provide an improved lantern assembly.

Another object of the present invention is to provide an oversized lantern adapted for generating light and heat while providing a campfire effect.

Still further objects and advantages will become apparent from a consideration of the ensuing description and drawings.

### BRIEF DESCRIPTION OF THE SEVERAL VIEWS OF THE DRAWINGS

FIG. 1 is a sectional view of a lantern according to the present invention;

FIG. 2 is a partial cutaway view thereof;

FIG. 3 is an exploded perspective view thereof;

FIG. 4 is an exploded top perspective view of the base and floating wick plate portion;

FIG. 5 is an exploded bottom perspective view thereof;

FIGS. 6 and 7 are perspective views of the wind shield and cap;

FIG. 8 is a perspective view of an alternate embodiment lantern adapted for use with an electric power source;

FIG. 9 is a side view thereof with the cap in an exploded configuration;

FIG. 10 is a side view thereof;

FIG. 11 is a perspective view thereof;

FIG. 12 is another exploded view thereof;

FIG. 13 is yet another exploded view thereof;

FIG. 14 is a perspective view of the cap;

FIG. 15 is a perspective view of a lantern according to the present invention disposed on a table; and

FIG. 16 illustrates the preferred embodiment in use without a cap.

### DETAILED DESCRIPTION OF THE INVENTION

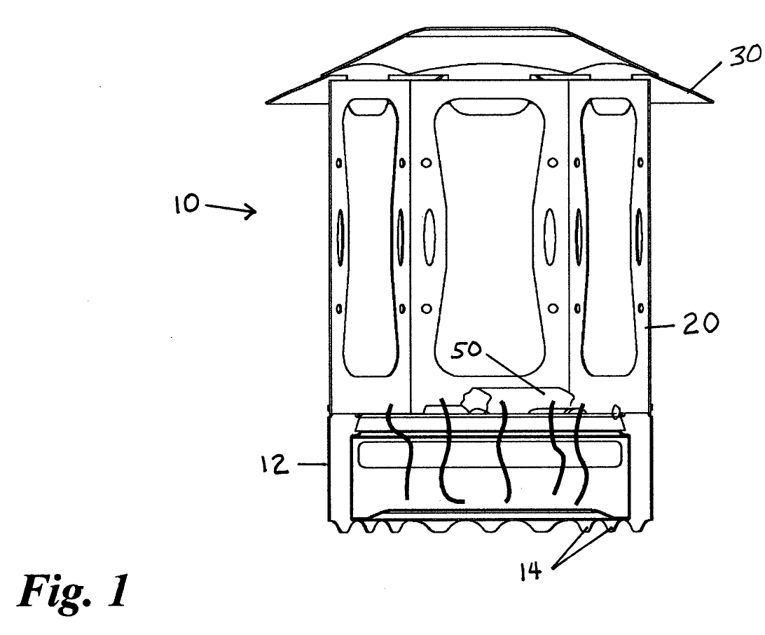

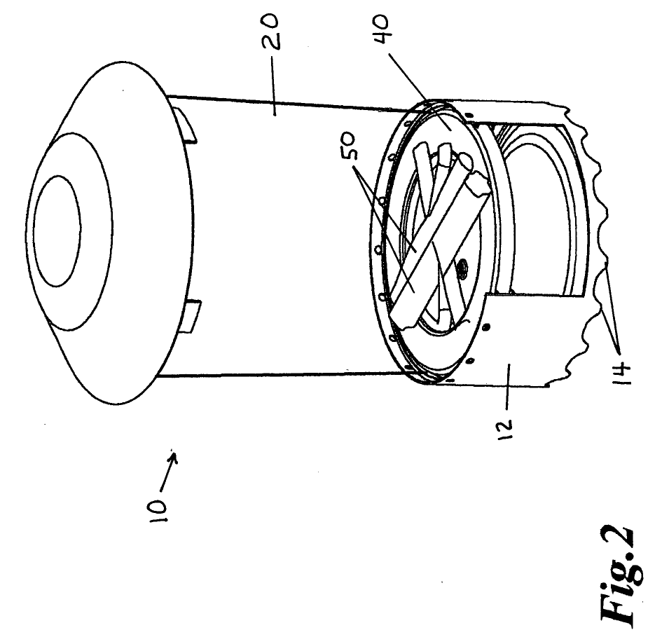

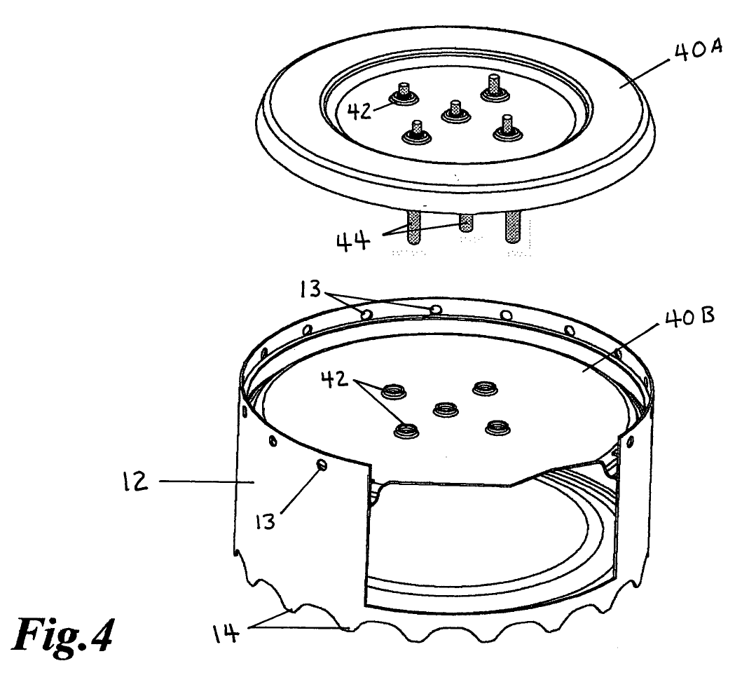

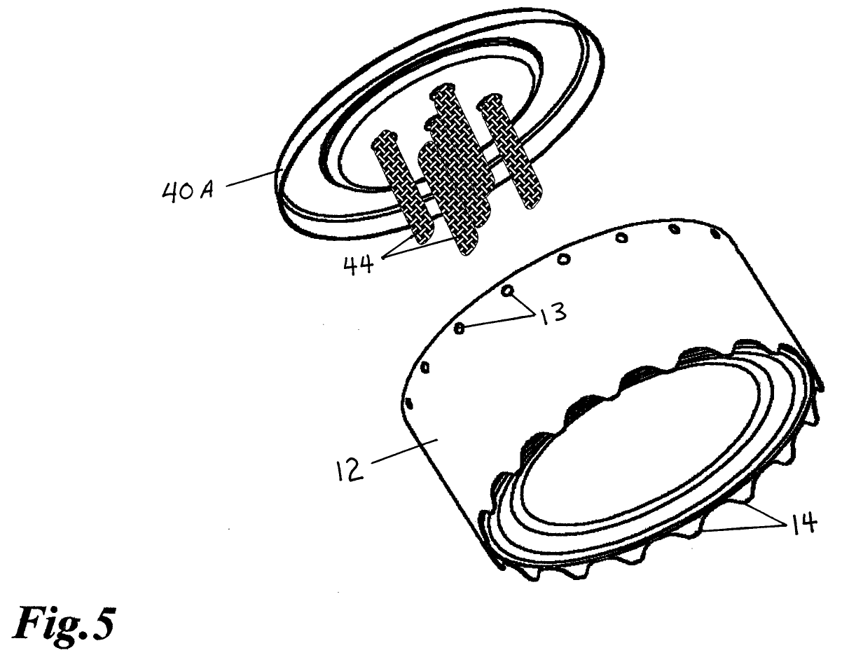

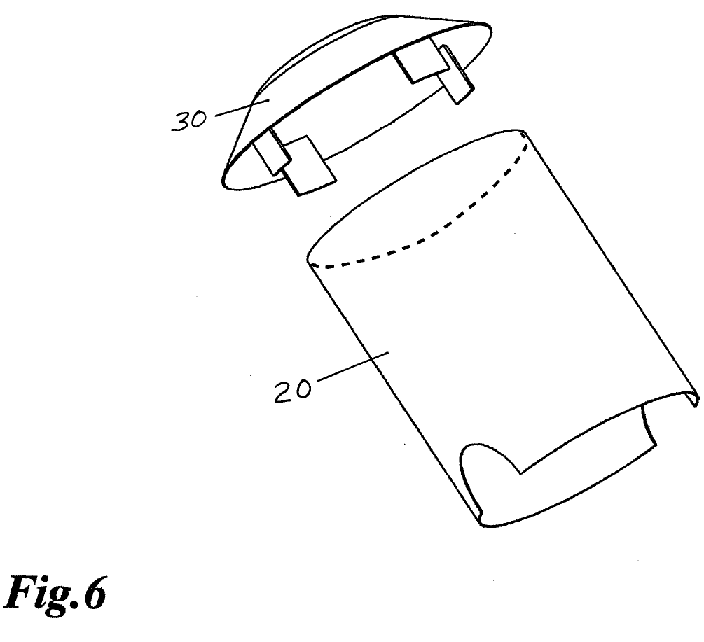

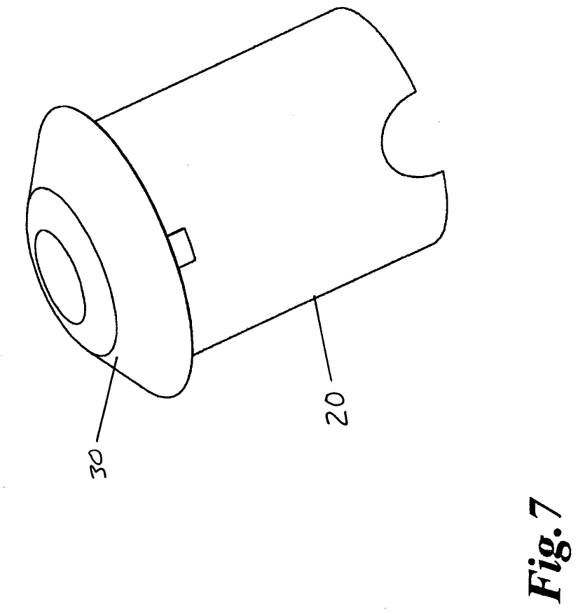

With reference now to the drawings, FIGS. 1-7 depict a lantern, generally referenced as 10, in accordance with the present invention. Lantern 10 comprises an oversized wind lantern capable of generating substantial amounts of light and heat, while providing the appeal of an open fire. Lantern 10 includes a base 12 that functions as a reservoir for liquid fuel, such as oil. Base 12 is preferably generally cylindrical and includes a lower peripheral edge that includes a plurality of downwardly projecting feet 14 for elevating base 12 above an underlying supporting surface. Base 12 is preferably fabricated from metal, such as aluminum, titanium, or steel. Lantern 10 is generally oversized, having a preferable diameter of between about 8″-14″, however, any suitable size is considered within the scope of the present invention. Base 12 further includes a generally cylindrical sidewall defining a plurality of ventilation apertures 13 for allowing combustion air to enter the lantern. As should be apparent, larger lantern assemblies produces more light and heat, than smaller assemblies, while requiring more fuel.

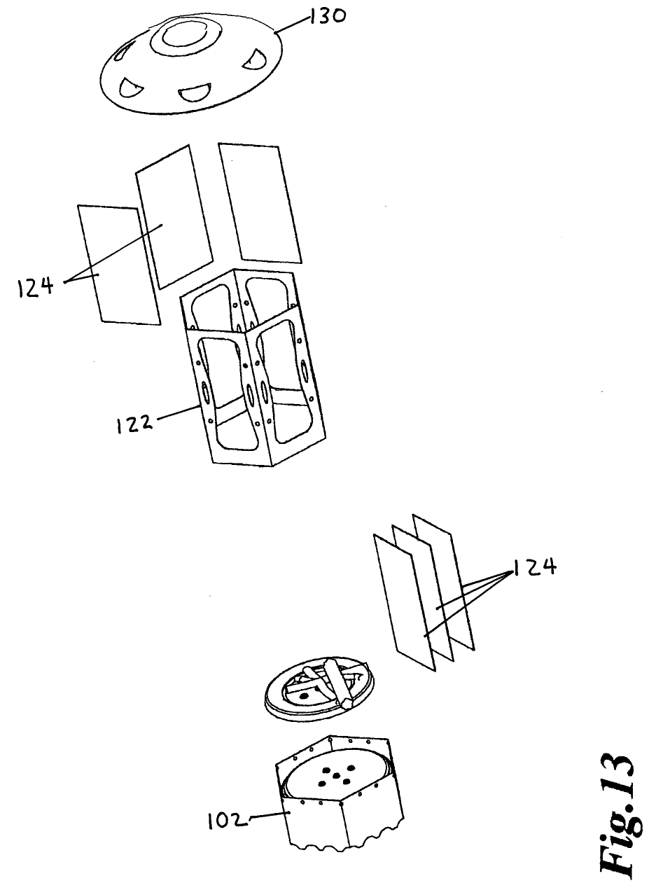

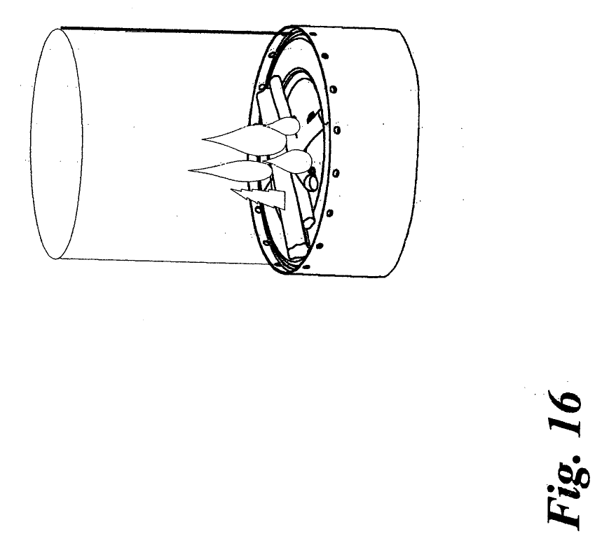

A transparent top enclosure 20 is attached to the base and functions as a wind shield. Transparent enclosure 20 may comprise a single piece of glass, such as the cylindrical open-topped wind shield depicted in FIG. 1, or may comprise a plurality of pieces fitted within a frame 22 to form a wind shield as depicted in FIG. 13. In either configuration, glass enclosure 20 includes a cap 30 adapted for mating engagement with glass enclosure 20 as depicted in FIG. 1. Cap 30 is preferably formed of metal in a shape having a sloped and/or convex upper surface that shields the lantern interior from wind and rain. As best illustrated in FIG. 16, the use of cap 30 is optional.

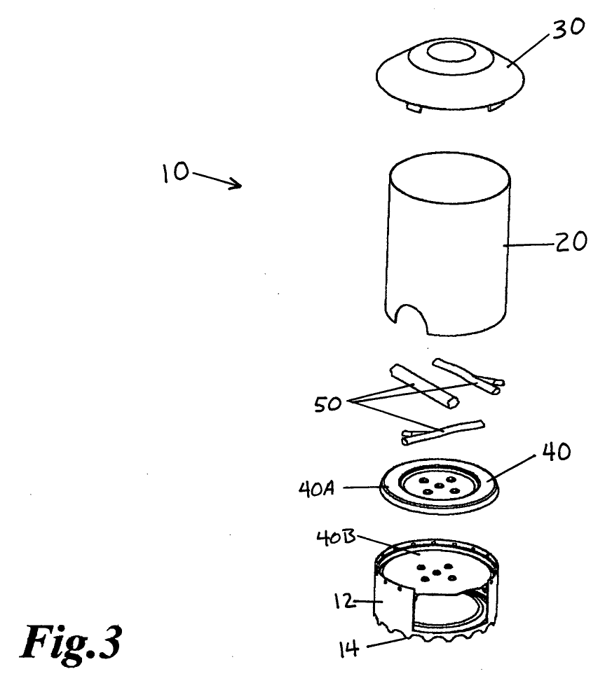

As best depicted in FIG. 3, an annular plate 40 is disposed within base 12 and adapted to float on top of the liquid fuel contained therein. Plate 40 includes connected upper and lower components, referenced as 40A and 40B respectively. Plate 40 defines a plurality of wick apertures 42, each of which is sized for receiving a correspondingly sized wick 44. As should be apparent, each wick 44 is insertably received within a corresponding wick aperture 42 such that a lower portion of the wick is in intimate contact with the liquid fuel disposed within base 12 below annular plate 40, and an upper portion projects above annular plate 40. Wicks 44 can be manually adjusted, prior to lighting, to increase or decrease the size of the simulated fire when lighted. As the fuel is consumed and the fuel level falls within base 12, plate 40—floating on the surface of the liquid fuel, drops as well.

In addition, a number of simulated logs 50 are disposed on annular plate 12. Simulated logs 50 are preferably fabricated from ceramic, however, any other suitable temperature resistant material is considered within the scope of the present invention. Logs 50 function as aesthetic accessories to provide the look and feel of a campfire, and further function as heat sinks to absorb and radiate heat.

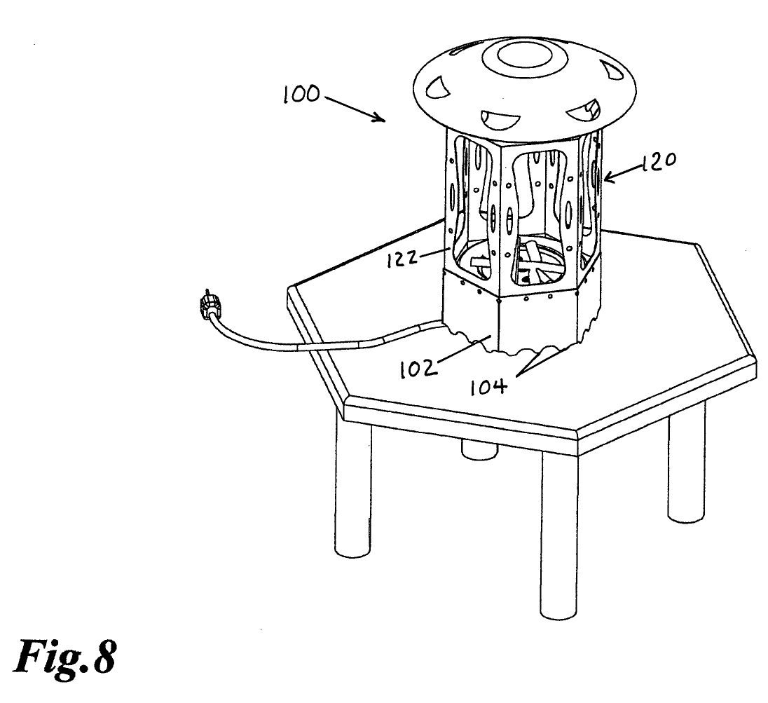

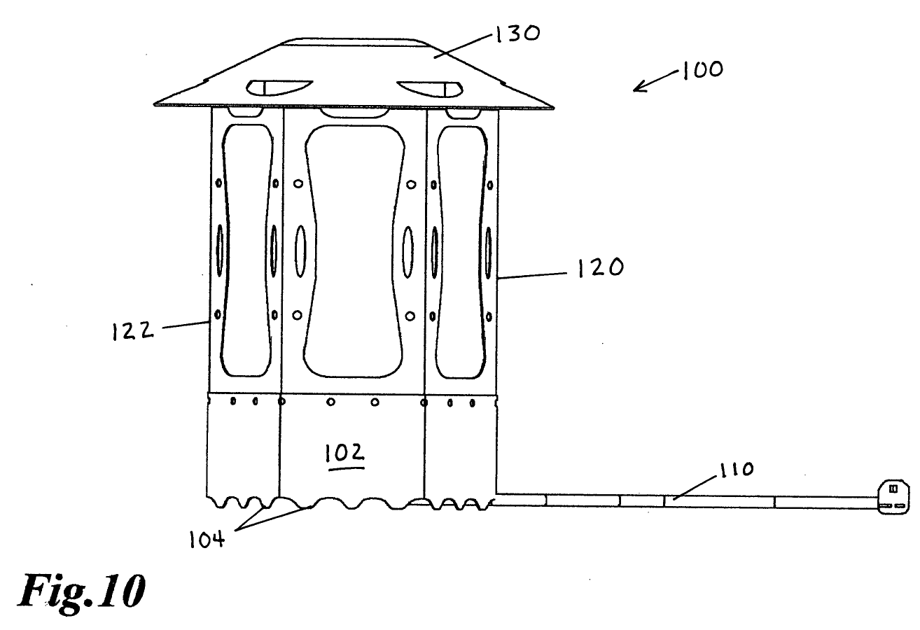

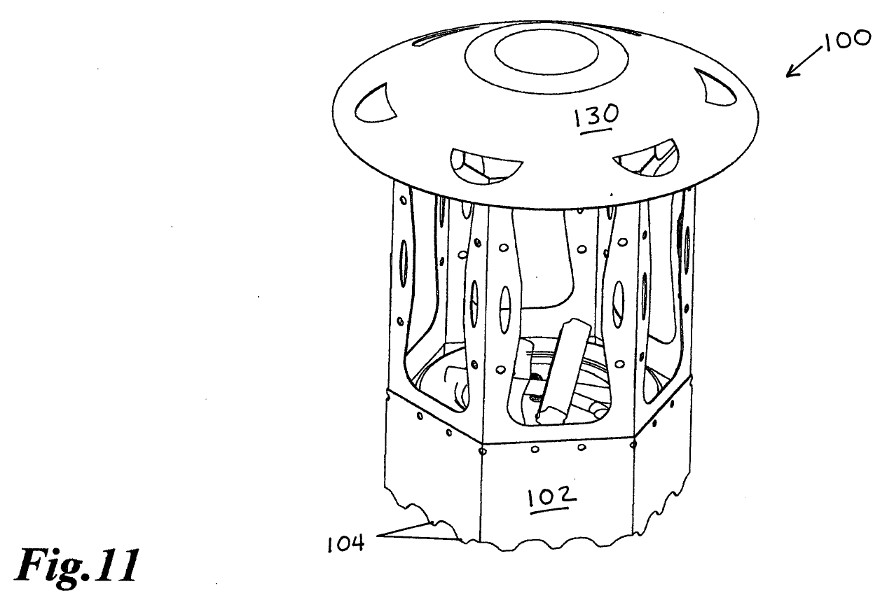

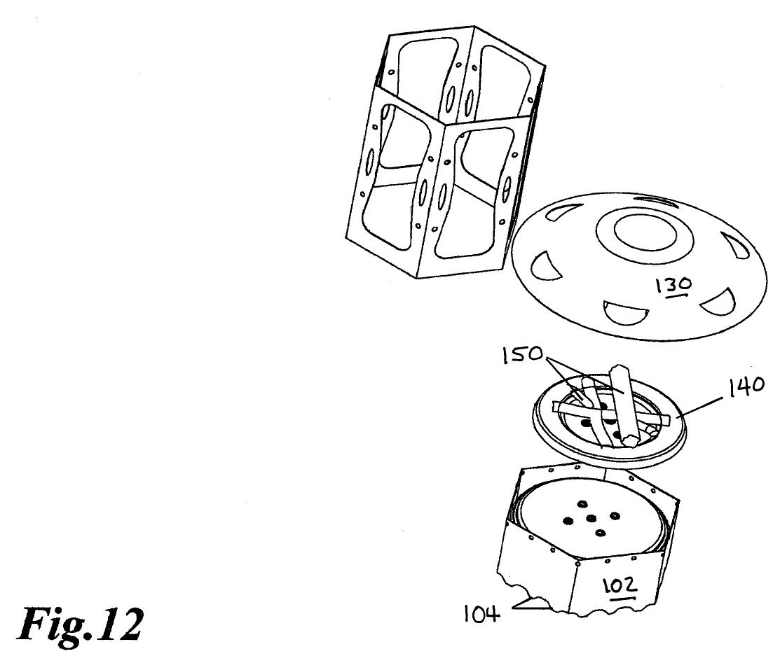

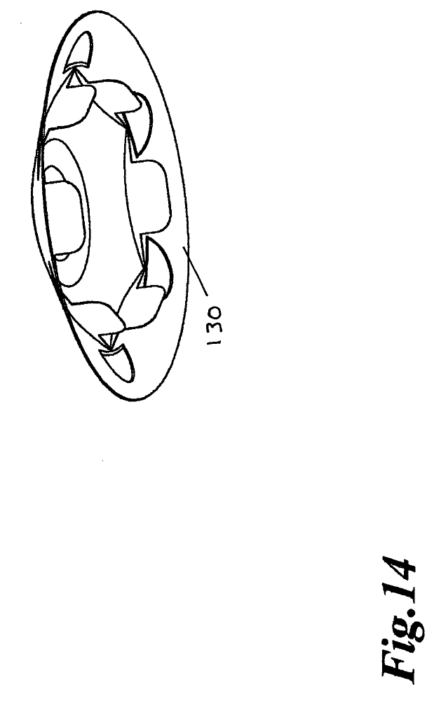

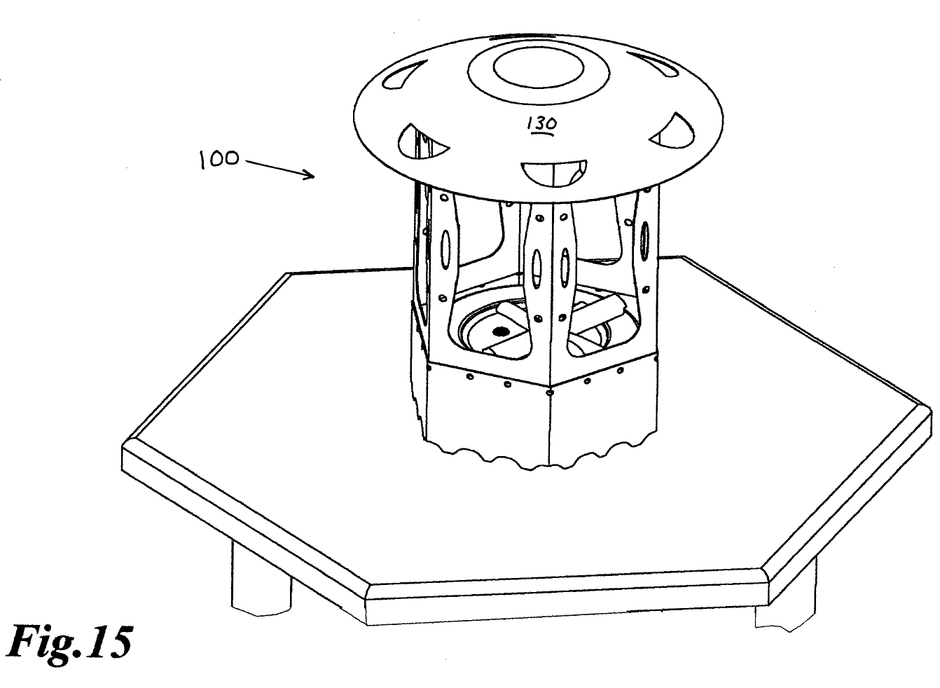

FIGS. 8-15 depict an alternate embodiment lantern, generally referenced as 100, wherein heat is generated by electrical resistance rather than by fire. Lantern 100 comprises an oversized lantern capable of generating substantial amounts of light and heat, while providing the appeal of a simulated fire. Lantern 100 includes a generally cylindrical base 102 that includes a lower peripheral edge that includes a plurality of downwardly projecting feet 104 for elevating base 102 above an underlying supporting surface. Base 102 is preferably fabricated from metal, such as aluminum, titanium, or steel. Lantern 100 is generally oversized, having a preferable diameter of between about 8″-14″, however, any suitable size is considered within the scope of the present invention. Base 102 further includes a generally cylindrical sidewall defining a plurality of ventilation apertures 13 for allowing air to enter the lantern. As should be apparent, larger lantern assemblies produces more light and heat, than smaller assemblies, while requiring more fuel.

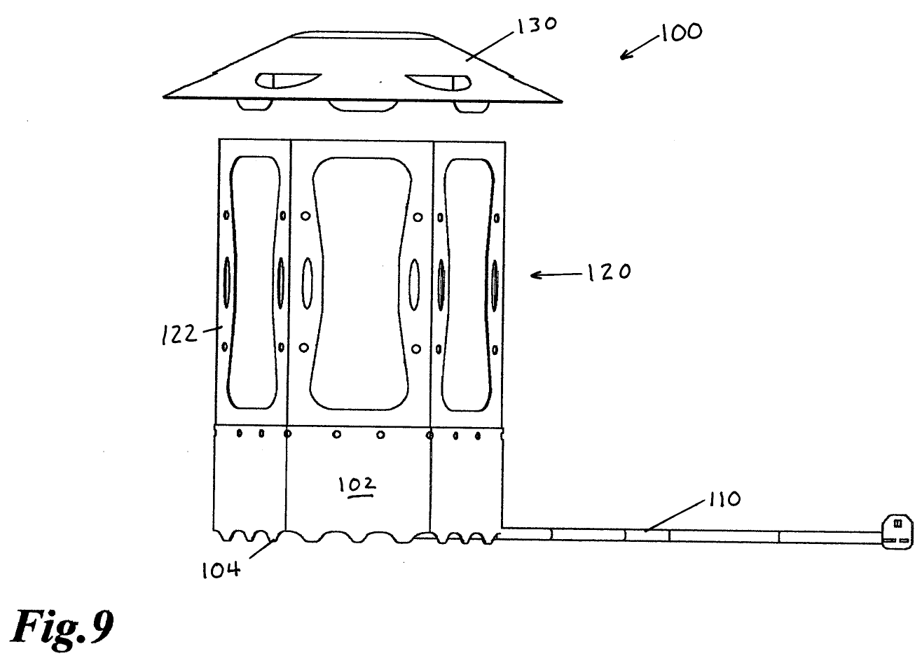

Lantern 100 further includes an enclosure, generally referenced as 120, attached to base 102. Enclosure 120 comprises a frame 122, and may further include a plurality of glass panels 124 fitted within a frame 122 to form a windshield as depicted in FIG. 13. Enclosure 20 includes a cap 130 adapted for mating engagement with glass enclosure 120 as depicted in FIG. 9. Cap 130 is preferably formed of metal in a shape having a sloped and/or convex upper surface that shields the lantern interior from wind and rain.

As previously discussed, lantern 100, is electrically powered. Accordingly, base 102 preferably includes an electric heating element (not shown) supplied with power by an electric power cord 110. In addition, base 102 includes a horizontal, generally planar surface 140 upon which a number of simulated logs 150 are disposed. Simulated logs 150 are preferably fabricated from ceramic, however, any other suitable temperature resistant material is considered within the scope of the present invention. Logs 150 function as aesthetic accessories to provide the look and feel of a campfire, and further function as heat sinks to absorb and radiate heat.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What I claim is:

1. A lantern for generating light and heat, said lantern comprising:
a base defining an interior reservoir and an open top;
liquid fuel contained within said reservoir;
a buoyant plate adapted to float on the surface of said liquid, said plate including top surface defining at least one thru bore, and a wick insertably disposed within said at least one thru bore such that a lower portion of said wick is in contact with said liquid fuel below said plate and an upper portion of said wick projects above said plate;
a plurality of simulated logs disposed on said plate top surface;
a transparent wind shield disposed on top of said base and in surrounding relation with said plate; and
a cap disposed on top of said wind shield.

2. A lantern for generating light and heat according to claim 1, wherein said simulated logs are ceramic.

3. A lantern for generating light and heat according to claim 1, wherein said base further includes a plurality of downwardly projecting feet.

4. A lantern for generating light and heat, said lantern comprising:
a generally cylindrical base defining an interior reservoir and an open top;
liquid fuel contained within said reservoir;
a buoyant plate adapted to float on the surface of said liquid, said plate including top surface defining a plurality of thru bores, and a wick insertably disposed in each of said thru bores such that a lower portion of said wick is in contact with said liquid fuel below said plate and an upper portion of said wick projects above said plate;
a plurality of ceramic simulated logs disposed on said plate top surface;
a transparent wind shield disposed on top of said base and in surrounding relation with said plate; and
a cap disposed on top of said wind shield.

5. A lantern for generating light and heat according to claim 4, wherein said base further includes a plurality of downwardly projecting feet.

6. A lantern for generating light and heat according to claim 4, wherein said base is generally cylindrical and has a diameter of between approximately 8 inches and 14 inches.
